(19) United States
(12) Patent Application Publication
(10) Pub. No.: US 2011/0185110 A1
(43) Pub. Date: Jul. 28, 2011

(54) METHOD AND DEVICE FOR PROTECTING INFORMATION CONTAINED IN AN INTEGRATED CIRCUIT

(75) Inventors: Tom Smigelski, Lake Zurich, IL (US); Dennis Cotner, East Dundee, IL (US)

(73) Assignee: SUMMIT DESIGN SOLUTIONS, INC., Hoffman Estates, IL (US)

(21) Appl. No.: 12/601,981

(22) PCT Filed: May 30, 2008
(86) PCT No.: PCT/US08/65183

§ 371 Date: Feb. 16, 2011

Related U.S. Application Data
(60) Provisional application No. 60/940,896, filed on May 30, 2007.

(51) Int. Cl. G06F 12/02

(52) U.S. Cl. 711/103; 711/E12.008

(57) ABSTRACT

An integrated circuit and a method of protection of an integrated circuit provides for a test controller state machine (TCSM) to be coupled to a control structure and/or an input and/or an output of at least one data storage device of the integrated circuit. The TCSM monitors the state of the data storage device and, upon a test request to the integrated circuit, causes the information in the data storage device to be changed or blocked until the data storage device is deemed safe for access. Such an integrated circuit and method protects information contained in data storage devices of the integrated circuit from being revealed during testing of circuitry of the integrated circuit.

### CROSS-REFERENCE TO RELATED APPLICATION

This application claims priority to U.S. Provisional Patent Application 60/940,896 filed May 30, 2007.

### TECHNICAL FIELD

The invention relates generally to the protection of information contained in an integrated circuit, and more particularly, is directed to protecting such information from attacks that exploit test structures of the internal circuitry.

### BACKGROUND ART

The manufacture of integrated circuits (IC) often requires a comprehensive test of all circuitry included on the IC to screen out any possible defects. The test should have a high fault grade to ensure high quality. A high fault grade requires that all circuitry included in the IC be both controllable and observable. During functional operation of the IC, the internal circuitry is often buried and inaccessible from the outside of the IC thus inhibiting testability. Several test techniques have been developed to make circuitry controllable and observable. The problem is that these test techniques might allow secret, confidential, proprietary, or restricted information, such as encryption keys, pass words, bank accounts, social security numbers, and other sensitive data or information, contained in data storage devices inside the IC to be inadvertently revealed to unauthorized parties.

This information may be contained in such storage devices, random access memories (RAMs), read only memories (ROMs), logic registers or non-volatile memories (NVMs), and might be revealed when unauthorized parties discover how to place the IC into test mode and read the secret information that may be stored inside. The NVMs may be Flash, EEPROM, EPROM, storage devices, or any other such non-volatile storage devices or elements. This invention describes a method and system to maintain secrecy of the information contained in an IC against possible attacks that exploit these test structures.

Several methods have been developed to aid in the comprehensive testing of integrated circuits: scan insertion, built in self-test (BIST), boundary multiplexing and JTAG (joint test action group) are examples.

Scan insertion involves replacing sequential elements with scannable sequential elements (scan cells) and then stitching those cells into scan chains. Data can be serially shifted in and out of these chains allowing these cells to be controlled and observed from outside of the IC.

BIST testing is used for higher-level storage cells such as RAMs, ROMs or other complex cells. This requires wrapping the complex cell inside circuitry that will apply a pre-determined test sequence on the inputs of the cell. In the case of a RAM this sequence will write prescribed patterns into the RAM and read the results out. In the case of a ROM, these inputs will just read out the contents. BIST also includes circuitry to compress or compare the outputs of the cell.

Boundary multiplexing may be used in certain circumstances where a cell has special test requirements that make it unsuitable for scan or BIST. This includes cells, such as NVMs, that might require analog connections during test. In this instance the inputs and outputs are multiplexed to the top-level pins on the outside of the IC allowing the automated tester to control and observe the cell directly. JTAG may also be used to provide a boundary register around this cell to allow the tester to control and observe this cell through the JTAG TAP port. Sometimes this JTAG is protected in order to prevent unauthorized outside access to information that was stored in NVM prior to entering test mode. If there is a scan chain that is also routed outside the IC via JTAG, then this technique prevents separate and parallel testing of the NVM and scan chain, which requires additional tester time.

These techniques, applied in various combinations, allow an IC to be tested thoroughly and thus achieve a high fault grade.

Prior art relies on ignorance on behalf of an attacker about the specifics of the test circuitry to maintain security of any secrets contained in the IC. Unfortunately, this cannot be guaranteed. If the IC to be tested contains encryption keys or other such secret information, the test circuitry is a tool that an attacker could use to gain access to this secret information. Prior art FIG. 1 shows various examples of open pathways that could be exploited in test mode. For example, if the secrets are stored in NVM, the attacker could put the IC in test mode, gain access to the memory and read the secret information out directly through the test pins of the IC. Or, an attacker could use JTAG to control and observe the boundary of the NVM and read the information out. If NVM information and scan chains are both routed outside the IC through JTAG, then additional tester time is required because separate and parallel testing of the NVM and scan chains is not possible.

In the event that direct access to the information is not available, the attacker might employ indirect methods. The IC may be run in normal functional mode until such time that the desired secret information has been transferred to register or RAM. In this case the IC can be placed in scan mode and the state of all the registers in the IC can be determined. The scan chain might also be exploited to read the data from the internal RAMs or ROMs and thus reveal any secret information contained therein.

If these methods are repeated, then an attacker can compare the various results to determine which information does not change. This may help him identify fixed items such as encryption keys that do not change.

### DISCLOSURE OF INVENTION

Embodiments of the invention advantageously provide for a method of protecting information contained in an integrated circuit (IC) from being revealed during testing of the integrated circuit unless or until the information is changed or otherwise deemed safe for access, the integrated circuit having a test controller state machine (TCSM) directly or indirectly coupled to control structure and/or input and/or output of at least one data storage device, the at least one data storage device having information stored therein and the IC having at least one normal functional mode of operation and at least one testing mode of operation. The method comprises the steps of:
(a) coupling, directly or indirectly, the TCSM with the integrated circuit to control and/or observe test structures of the integrated circuit,
(b) causing the TCSM upon a request to test the integrated circuit to enter an erase mode, and
(c) performing during the erase mode, either individually, sequentially, or concurrently, one or more of the following steps: (1) activating a built in self-test (BIST) on one or more of the data storage devices until the information in the data storage device has been deemed safe for access, and/or (2) changing the information of one or more of the data storage device until the information in the data storage device has been deemed safe for access, and/or (3) destroying the information contained in any scan cells of the integrated circuit until any information in the scan cells has been erased or deemed safe for access.

An embodiment of the invention also provides for an integrated circuit that comprises (a) at least one data storage device wherein said data storage device has information stored therein and the integrated circuit has at least one normal functional mode of operation and at least one testing mode of operation, and (b) a test controller state machine (TCSM) directly or indirectly coupled to at least one data storage device wherein the TCSM includes implementation means for causing the information in the at least one data storage device to be protected from outside access unless or until the at least one data storage device is deemed safe for access.

The prior art problems previously discussed are addressed by including a test controller state machine (TCSM) to prevent access to control or observe via the test structures until such time that all the protected information has been destroyed or otherwise deemed safe for access. One way to destroy information is via reset as shown in FIGS. 2 and 6. The concept of preventing access to control and observe information from outside the IC is shown in FIG. 2. One specific way to implement access prevention is by using AND gates and multiplexers that either enable or block outside access to sensitive circuits as desired, such as in FIGS. 4, 5, and 6. The access prevention can also be implemented with other configurations of logic such as NAND gates etc. Controlling those various gates which prevent access can be accomplished by connecting those gates to circuits composed of various technologies as desired based on cost or complexity. Examples are other logic gates, antifuse, One Time programmable (OTP), NVM, etc. The access prevention gates as shown in FIGS. 4, 5, and 6 are initialized into blocked mode at either power up or reset, and then held there unless and until all the data in any particular sensitive circuit is destroyed or otherwise deemed safe for access. If the data in any particular sensitive circuit is not destroyed for any reason, or not deemed safe for access, then these access prevention gates are simply held in blocked mode. Another way to effectively destroy information is to simply hold these access prevention gates in blocked mode until all sensitive information is shifted out of any sensitive registers. An example of this technique is shown in FIG. 6, where access prevention gates can be held in blocked mode until the appropriate scan counters reach terminal count. At that point sensitive information has been shifted out. Permanently holding access prevention gates in blocked mode eliminates the need to destroy the data in any particular sensitive circuit.

The TCSM has a “test request” input. Upon assertion of the “test request” input the TCSM will kick off several processes depending on what test structures are contained in the IC.

One process initiates an erase cycle of the non-volatile memory (FIG. 2, Process 1). If this process is utilized, outside access to information contained in non-volatile memory is not possible until entering the appropriate “safe” portion of test mode after erasing the information. The advantage of erasing this information is that an unauthorized person cannot steal the information that was previously contained in non-volatile memory prior to entering the safe portion of test mode. This does not prevent the chip from being thoroughly tested because information can still be entered or read at will after entering the appropriate portion of test mode via the following process. Assume the chip is operating in normal mode and a test request is initiated, and it is desired to erase the information contained in non-volatile memory before allowing access to the NVM. Since an erase cycle may take several milliseconds, the TCSM has an erase timer that will cause it to wait until the desired erase time has elapsed. Once the erase timer has expired the TCSM will then read all the information in the non-volatile memory to verify that it has indeed been erased. If the data in the non-volatile memory is not completely erased the TCSM will initiate another erase cycle. This loop will repeat until it has verified that all the data in the non-volatile memory has been completely erased. This prevents an attacker from clocking the circuit at a higher frequency than intended, thus short-cycling the erase timer and circumventing a full erase cycle. Under no circumstances will the TCSM allow test access to the memory until it has verified that all data in the memory has been erased. At this point, direct outside access to non-volatile memory via the access prevention gate(s) can become safely enabled by holding the “Read Enable From Test Controller” pins high (unblocked) FIG. 5. At other times, such as when the above process is not utilized or is not required, then direct outside access to non-volatile memory via the access prevention gate(s) is blocked by holding the “Read Enable From Test Controller” pin low (blocked) FIG. 5.

Since the RAMs must be tested anyway, another process (FIG. 2, Process 2) initiates BIST and waits for BIST to complete. The BIST process writes test information into any RAMs and thus over-writes any sensitive information that might have been therein. The TCSM will not allow a safe test mode to commence until BIST of all RAMs has been completed.

Since the various processes might take different times to complete, the TCSM will wait for all the processes to complete before it will allow the IC to go into scan open mode. Prior to entering scan open mode, the TCSM will take steps (FIG. 2, Process 3) to ensure that the existing data in the scan chain cannot be read out. One technique is to apply reset to all the scan cells thus destroying the data. If any registers are not part of the scan chain, they can also be erased to destroy data as desired. An alternative, lower cost approach to destroying information contained in scan cells may also be used where the scan chain outputs are held constant until the scan chains have been completely shifted out for the first time. Since the first step in scan test is to shift test data into the scan chains, the two functions overlap without costing any time. The TCSM will count the number of shift cycles and will hold the output of each scan chain constant until as many clock cycles as the length of scan chains have elapsed. From this point on, the IC is in test mode where the scan test and non-volatile memory test may now proceed as in prior art.

In order to minimize testing time for ICs, it is desired to test NVMs separately but in parallel with the scan chains. One benefit of this invention allows the NVMs to safely be tested separately and in parallel with the scan chains, especially when protected JTAG is used to route the information outside the IC. Another benefit of this invention is that the test request input can also be asserted by tamper sensing circuits to protect information in the event of a tamper attack.

### BRIEF DESCRIPTION OF DRAWINGS

A fuller understanding of the foregoing may be had by reference to the accompanying drawings, wherein:

FIG. 1 is a block diagram of a prior art IC having various open pathways which could be exploited in test mode to gain access to control or observe secret information.

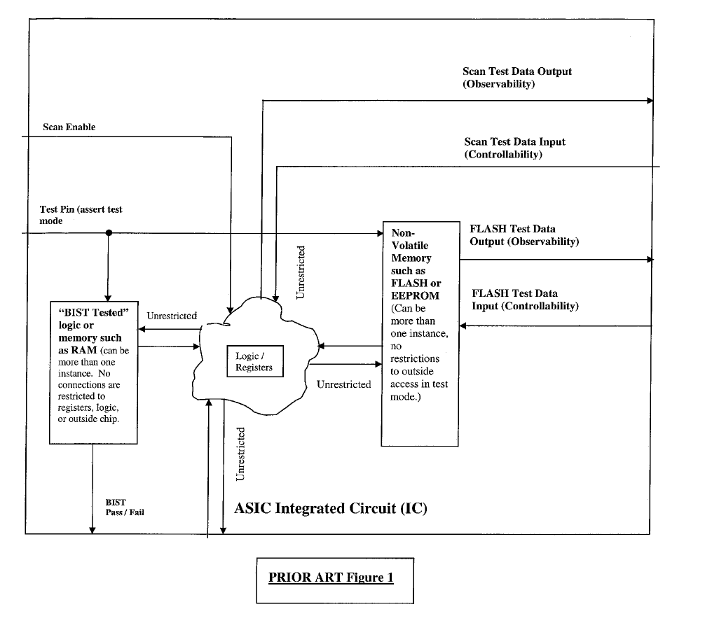

FIG. 2 is a schematic diagram of the IC test control system overview of the invention illustrating the TCSM interaction with Process 1, Process 2, and Process 3 to prevent access to control or observe secret information.

FIG. 3 is a schematic diagram of the Process 2 BIST start through done TCSM interaction to completely test the RAMs, ROMs, or other cells.

FIG. 4 is a schematic diagram of TCSM interaction relative to the non-BIST tested RAMs, ROMs, or other cells.

FIG. 5 is a schematic diagram of TCSM interaction relative to the non-volatile memory testing of Process 1.

FIG. 6 is a schematic diagram of TCSM interaction relative to the scan chain testing of Process 3.

### MODES FOR CARRYING OUT THE INVENTION

While the invention is susceptible to embodiments in different forms, there are shown in the drawings and will be described herein, in detail, the preferred embodiments of the invention. It should be understood, however, that the present disclosure is to be considered an exemplification of the principles of the invention and is not intended to limit the spirit or scope of the invention and/or claims of the embodiments illustrated.

These problems are addressed by including a test controller state machine (TCSM) to prevent access to control or observe via the test structures until such time that all the protected information has been destroyed. Prevention of access and control is achieved by gates or similar circuits that either enable or block access as desired.

The TCSM has the characteristics of a finite state machine (FSM) or a finite state automaton (plural: automata), namely it is a model of behavior composed of a finite number of states, transitions between those states, and actions.

A state stores information about the past, i.e. it reflects the input changes from the system start to the present moment.

A transition indicates a state change and is described by a condition that would need to be fulfilled to enable the transition.

An action is a description of an activity that is to be performed at a given moment. There are several action types:

Entry action—which is performed when entering the state

Exit action—which is performed when exiting the state

Input action—which is performed depending on present state and input conditions, and

Transition action—which is performed when performing a certain transition.

In a digital circuit, an FSM may be built using such items as a programmable logic device, a programmable logic controller, logic gates and flip flops or relays. More specifically, a hardware implementation requires a register to store state variables, a block of combinational logic which determines the state transition, and a second block of combinational logic that determines the output of an FSM.

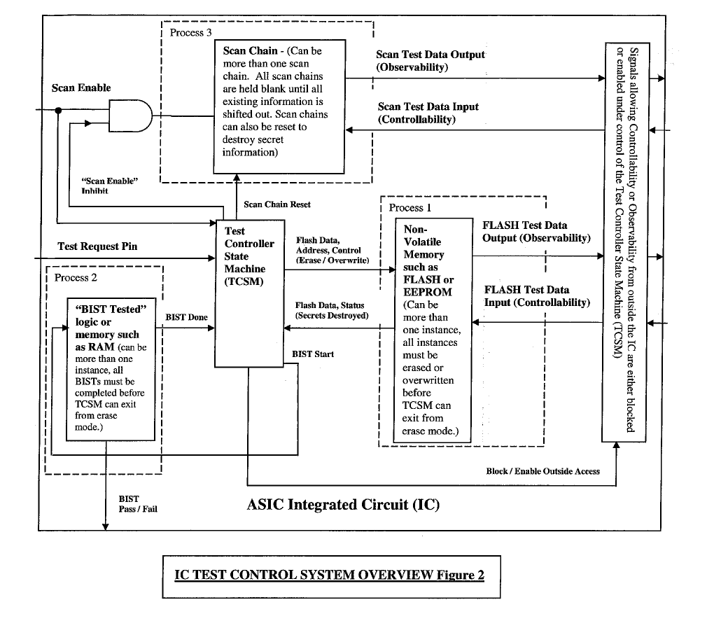

Referring to FIG. 2, the IC may contain one or more of RAM, ROM, NVM, and scan chains. The TCSM is a sequential circuit that coordinates the various testability functions hereinafter shown and described. It is required that the sequential elements of the TCSM not be part of any scan chains. Inclusion of these elements into any scan chain would allow an attacker to take control of the TCSM via the scan chain, and thus circumvent its intended function. Putting the TCSM through its functional operations will test it, since it cannot be tested via the scan chains.

As shown in the following table, the TCSM has four major modes. In this case, the first mode is normal functional operation of the IC and the test operation is divided into the remaining three modes. It is possible for a TCSM to have less than four modes or more than four modes, depending on user requirements.

| TCSM | | |
|---|---|---|
| Mode | IC Mode | Description |
| Idle | Functional | The IC is configured in its normal functional mode. BIST is |
| | | reset. All test multiplexers are configured to select normal |
| | | functional signals. Scan enable is inhibited. Test access to |
| | | NVM is blocked. |
| Erase | Protect | The IC is configured to protect sensitive information while |
| | | erasing. RAMs and ROMs are BIST tested. NVMs are |
| | | erased. Scan enable is inhibited. Test access to NVM is |
| | | blocked. |
| Scan1 | Scan | The IC is configured in scan mode. Scan enable is |
| | blocked | controllable. Scan chain outputs are blocked. Test access to |
| | | NVM can be enabled if erased. |
| Scan2 | Scan open | The IC is configured in scan mode. Scan enable is |
| | | controllable. Scan chain outputs are unblocked. Test access to |
| | | NVM can be enabled if erased. |

Upon reset and/or power-up the TCSM will be in “Idle” mode. In “Idle” mode, the IC will be configured to operate in functional (non-test) mode. The RAMs, ROMs and NVMs will be connected to perform the normal function of the IC, and the scan chains will be inhibited. It is in this mode that the IC performs the normal function for which it was ultimately designed.

The TCSM has a “test request” input that will command it to prepare the IC for testing. Upon assertion of the “test request” input, the TCSM will enter “Erase” mode and will perform several processes, either sequentially or concurrently, to perform BIST on RAMs or ROMs (FIG. 2, Process 2) and to erase any NVMs (FIG. 2, Process 1). It will remain in this mode until such time that all NVMs have been erased and that the data in any RAMs has been overwritten by BIST or is otherwise blocked or deemed safe for access.

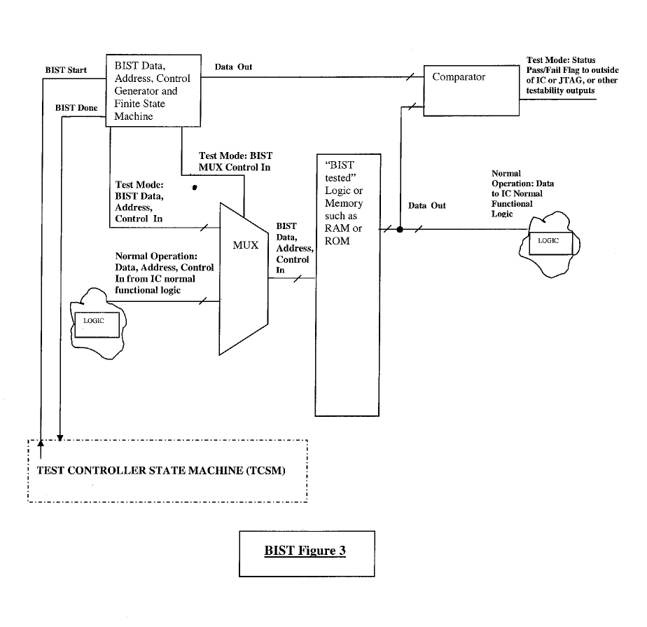

During “Erase” mode, if the IC contains RAMs or ROMs the TCSM will place these devices in BIST mode. In BIST mode, the inputs to the RAMs and ROMs will be controlled by a BIST controller rather than by the circuitry that normally controls it. Referring now to FIG. 3, the BIST controller will generate the proper sequence of signals to completely test the RAMs or ROMs. The BIST controller will also observe the outputs of the RAMs or ROMs and will perform comparison of the outputs. The BIST controller will provide pass/fail signals to the exterior of the IC either directly or through JTAG to indicate whether the RAM or ROM under test is functioning correctly. The data itself will not be coupled directly or indirectly to the outside of the IC.

While in this mode, the RAMs and ROMs can be controlled/observed only by the BIST controller and nothing else. This condition will persist as long as the TCSM is in “Erase” mode. A RAM may be reconnected to its functional mode inputs/outputs and/or outside IC boundary after completion of BIST. At this point in time there is no longer any danger of revealing any secret information that was contained in the RAM because any data in the RAM has been overwritten during the BIST test and deemed safe for access. This allows the interface between the functional logic and the RAM to be tested. In the instance that a particular ROM doesn't contain any sensitive information, it may also safely be connected to the normal functional logic and/or outside IC boundary.

It is also imperative that the sequential elements of the BIST controller not be included in any of the scan chains in order to prevent an attacker from taking control of the BIST controller and thus circumventing its intended function.

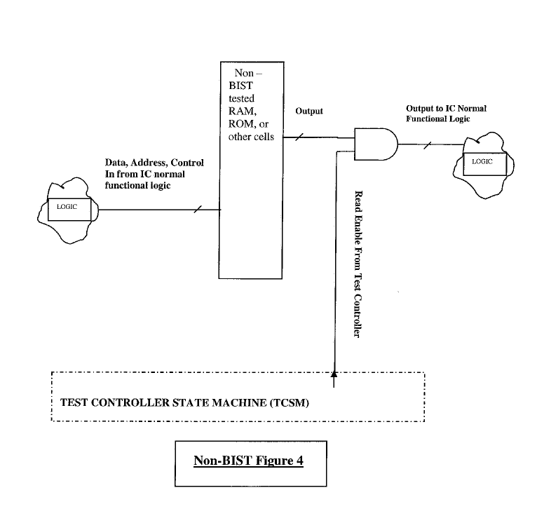

In the event that a RAM, ROM or other cell not require BIST testing (for example if they can be verified in functional mode by a functional test) a means may be provided to prevent these cells from being controlled or observed either directly or indirectly either through the scan chains, JTAG or through any top level pin. One possible way of accomplishing this would be to provide an “AND” gate between every output of the cell and its functional destination (as shown in FIG. 4). The other input of these “AND” gates will be high only when the IC is in normal functional mode, and the TCSM is in “Idle” mode.

Also, while the TCSM is in “Erase” mode, and if the IC contains an NVM the TCSM will first go through the process of obliterating the data in the NVM before placing it in a mode where it can be tested. The TCSM will first check to see if the NVM is already erased and deemed safe for access. If not erased, it will initiate an erase cycle of the NVM. Since an erase cycle may take several milliseconds, the TCSM has an erase timer that will cause it to wait until the desired erase time has elapsed. Once the erase timer has expired the controller will then read all the information in the NVM again to verify that it has indeed been erased and deemed safe for access. This process will repeat until the TCSM has verified that the NVM is completely erased. This prevents an attacker from clocking the circuit at a higher frequency than intended, thus short-cycling the erase timer and circumventing a full erase cycle.

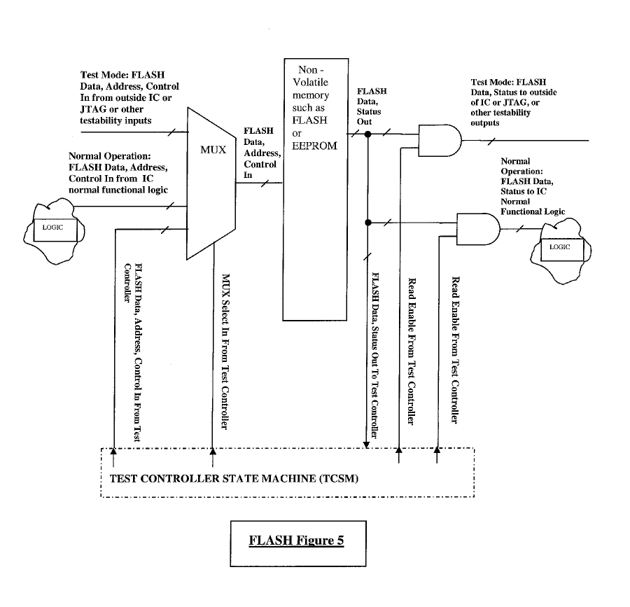

Referring now to FIG. 5, in order to erase the NVM, the TCSM will take over control of all the NVM's inputs and obscure the NVM's outputs to the outside of the IC.

Using those inputs the TCSM will sequentially perform the following steps:
1) Start at the first location in memory.
2) Read the content of the current location.
3) Is the content of this location erased?
   a) Yes, go to step 4.
   b) No, go to step 6.
4) Is this the last location?
   a) Yes, go to step 8.
   b) No, go to step 5.
5) Proceed to the next location in memory. Go to step 2.
6) Begin an erase cycle. Start erase timer.
7) Is erase timer expired?
   a) No, stay in step 7.
   b) Yes, go to step 1.
8) Memory is now erased. The inputs/outputs of the memory may now be connected to the top level IC pins, JTAG register or other means used for testing the NVM.

Referring to FIG. 5, direct outside access to non-volatile memory via the access control AND gate(s) can now become safely enabled by holding the “Read Enable From Test Controller” pins high (unblocked). At other times, such as when the above steps are not utilized, not required, or not successful, then direct outside access to non-volatile memory via the access control AND gate(s) can be blocked by holding the “Read Enable From Test Controller” pin low (blocked).

It is also understood that instead of erasing the NVM, all locations may be written instead to allow the NVM to be safe for access. The same process as above is followed, but with the erase cycle being replaced with a write cycle to the current location. This alternative might be preferred in some instances because writing of data to some NVMs is much quicker than erasure. In some instances, such as EPROM, the data cannot be electrically erased and therefore can only be obscured by writing. Also any writing over of information to be protected from revelation is preferably done more than once and when so written over is preferably written over using different or random write over patterns.

Since these various processes might take different times to complete, the TCSM will remain in “Erase” mode until all BIST has been completed and all NVMs have been erased before proceeding to the “Scan1” mode. At this point all RAMs and NVMs are clear of any sensitive information and therefore deemed safe for access. The scan chain, however, might still contain sensitive information.

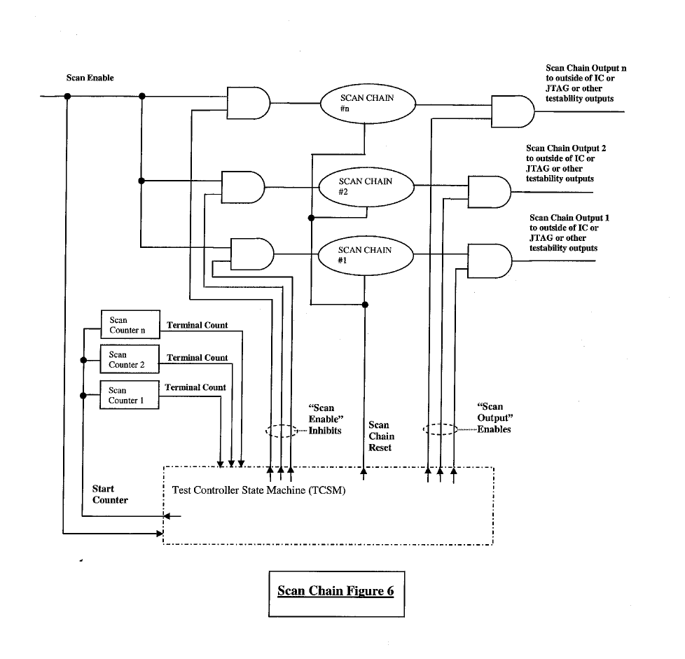

Referring now to FIG. 2 Process 3 and FIG. 6, in order to obliterate this scan chain information, the TCSM could reset all of the scan cells before entering “Scan2” mode. Alternatively it could send a signal to a gate at the terminus of each scan chain that will block the data. It will also set up a counter that will keep track of the number of times that the scan chains have been shifted. Once enough cycles have elapsed to guarantee that any data previously held in those chains has been shifted out to be deemed safe for access, the TCSM can then enter the “Scant” state. In the “Scan2” state the gate at the terminus of each scan chain can now be opened. This technique is usually cheaper in gate count than resetting all the scan cells. There is no time penalty either because the first step in a scan test is to shift in the first vector. The shifting of the first vector and clearing of the scan chain are thus overlaid.

From this point on, the IC is in scan test mode “Scan open”. The scan test and NVM test may now proceed as in prior art.

Various programming can implement the TCSM control and interactions described herein. Such programming can be modified as desired to block outside access to secret information contained in one or more sensitive circuits until and unless it is deemed safe to access the information. The following is an exemplary robust TCSM implementation written in Verilog:

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

The foregoing programming contains at least one instance of the various types of circuits such as NVM, scan chains, and BIST tested circuits previously discussed. Such programming can be used “as is”, or can be modified as desired to block outside access to information contained in one or more instances of each of these types of circuits until, and unless, it is deemed safe to access the information. In this programming implementation, each of these circuits can be safely tested and re-tested as many times as desired, and whenever desired. A user may also permanently deny outside access to the information in any particular circuit by simply holding access to its information permanently blocked to reduce complexity or cost. The access prevention gates and multiplexers themselves can be implemented and controlled by the TCSM as a separate entity, but can also be incorporated inside the TCSM depending on user preference.

From the foregoing and as mentioned above, it will be observed that numerous variations and modifications may be effected without departing from the spirit and scope of the novel concept of the invention. Preventing access to control or observe information in each of these circuits is determined by system requirements and individual user preferences. It is to be understood that no limitation with respect to the specific methods and apparatus illustrated herein is intended or should be inferred. For example, the instant invention may be employed with an IC that does not have both NVM and RAM memory as the IC may only include a NVM without a RAM memory portion or vice versa. It is, of course, intended to cover by the appended claims all such modifications as fall within the scope of the claims.

### INDUSTRIAL APPLICABILITY

The embodiments of the method for protecting information contained in an integrated circuit and the disclosed integrated circuit advantageously protects information contained in a data storage device of integrated circuit from being revealed by attacks that exploit test structures of the internal circuitry.

What is claimed:

1. A method of protecting information contained in an integrated circuit (IC) from being revealed unless or until the information is changed or otherwise deemed safe for access, the integrated circuit having a test controller state machine (TCSM) directly or indirectly coupled to control structure and/or input and/or output of at least one data storage device, the at least one data storage device having information stored therein and the IC having at least one normal functional mode of operation and at least one testing mode of operation, comprising the steps of:
(a) coupling, directly or indirectly, the TCSM with the integrated circuit to control and/or observe test structures of the integrated circuit,
(b) causing the TCSM upon a request to test the integrated circuit to enter an erase mode, and
(c) performing during the erase mode, either individually, sequentially, or concurrently, one or more of the following steps: (1) activating a built in self-test (BIST) on one or more of the data storage devices until the information in the data storage device has been deemed safe for access, and/or (2) changing the information in one or more of the data storage device until the information in the data storage device has been deemed safe for access, and/or (3) changing the information contained in any scan cells of the integrated circuit until any information in the scan cells has been erased or deemed safe for access.

2. The method of claim 1 including a step of verifying that the information in the data storage device and/or the scan cells has been changed or deemed safe for access before allowing a safe mode for testing of the integrated circuit.

3. The method of claim 2 further including a step of entering the TCSM into a safe mode and causing the integrated circuit to enter a safe mode for testing.

4. The method of claim 2 including a step of verifying the changing of the information by using a repeatable timed cycle monitored by the TCSM which does not allow commencement of the safe mode for testing until information in at least one of the data storage device or the scan cells has been erased or deemed safe for access.

5. The method of claim 2 wherein the step of verifying that the information has been erased or deemed safe for access includes a step of performing a read operation, to prevent commencement of the safe mode for testing until the information in the data storage device or the scan cells has been erased or deemed safe for access.

6. The method of claim 2 wherein the step of verifying includes a step of waiting a predetermined amount of time before the TCSM will allow commencement of the safe mode for testing until information in the data storage device or the scan cells has been erased or deemed safe for access.

7. The method of claim 1 including the step of causing the TCSM to be a finite state machine or a finite state automaton for providing a model of behavior composed of a finite number of states, transitions between the states, and actions.

8. The method of claim 1 including a step of preventing the TCSM from being a part of any scan chain.

9. The method of claim 1 including a step of selecting the data storage device from the group consisting of random access memory (RAM), read only memory (ROM), higher-level cells, logic registers, non-volatile memory (NVM), Flash, EPROM, and EEPROM.

10. The method of claim 1 wherein the step of performing includes a clearing, resetting, writing over, shifting out, obliterating, destroying, or blocking of the information while outputs are blocked from outside access.

11. The method of claim 10 wherein the writing over is done more than once.

12. The method of claim 11 wherein the writing over done more than once is performed with different or random patterns.

13. The method of claim 1 further including the step of accessing the information during the test mode by direct access, boundary multiplexing, and/or joint test action group (JTAG).

14. An integrated circuit comprising:
(a) at least one data storage device wherein said data storage device has information stored therein and the integrated circuit has at least one normal functional mode of operation and at least one testing mode of operation, and
(b) a test controller state machine (TCSM) directly or indirectly coupled to at least one data storage device wherein the TCSM includes implementation means for causing the information in the at least one data storage device to be protected from outside access unless or until the at least one data storage device is deemed safe for access.

15. The integrated circuit according to claim 14 wherein the TCSM includes means for preventing an output of the data storage device until the information contained therein is fully changed or deemed safe for access.

16. The integrated circuit according to claim 14 wherein the data storage device includes a built-in means for self-testing the data storage device.

17. The integrated circuit according to claim 14 wherein the at least one data storage device is random access memory (“RAM”).

18. The integrated circuit according to claim 17 wherein the TCSM includes means for preventing access to the RAM until the self-test has changed the information stored on the RAM.

19. The integrated circuit according to claim 14 wherein the TCSM includes means for causing the at least one data storage device to erase information stored therein.

20. The integrated circuit according to claim 14 wherein the TCSM includes means for causing the at least one data storage device to write over the information contained therein.

21. The integrated circuit according to claim 14 wherein the TCSM includes means for causing the at least one data storage device to shift out the information contained therein.

22. The integrated circuit according to claim 14 wherein the at least one data storage device has non-volatile memory.

23. The integrated circuit according to claim 14 wherein said at least one data storage device is selected from the group consisting of random access memory (RAM), read only memory (ROM), higher-level cell, logic register, non-volatile memory (NVM), Flash, EPROM, and EEPROM.

24. The integrated circuit according to claim 14 wherein the TCSM includes a timing means for allowing enough time to expire such that the stored information is completely erased.

25. The integrated circuit according to claim 14 wherein the TCSM includes:
(a) a timing means for allowing enough time to expire such that the stored information is erased, and
(b) additionally includes a verifying means for verifying that the information was actually erased.

26. The integrated circuit according to claim 14 wherein the TCSM includes a counting means for allowing enough clock cycles to expire such that the stored information is clocked out or otherwise deemed safe for access.

27. The integrated circuit according to claim 14 wherein the TCSM includes means for changing the information contained on the at least one data storage device by erasure, overriding, destroying, shifting out, blocking or clearing.

28. The integrated circuit according to claim 14 wherein the TCSM includes means for observing the information contained on the at least one data storage device by direct access, boundary multiplexing, and/or joint test action group (JTAG).
